(19) United States
(12) Patent Application Publication
(10) Pub. No.: US 2014/0235740 A1
(43) Pub. Date: Aug. 21, 2014

(54) HEAT RESISTANT POLYLACTIC ACID COMPOUNDS

(71) Applicant: Jing Liu, Avon, OH (US)

(72) Inventor: Jing Liu, Avon, OH (US)

(73) Assignee: POLYONE CORPORATOIN, Avon Lake, OH (US)

(21) Appl. No.: 14/240,471

(22) PCT Filed: Aug. 23, 2012
(86) PCT No.: PCT/US12/52057

§ 371 Date: Feb. 24, 2014

Related U.S. Application Data
(60) Provisional application No. 61/527,478, filed on Aug. 25, 2011.

(51) Int. Cl. C08L 69/00; C08L 67/04

(52) U.S. Cl. CPC C08L 69/00; C08L 67/04
USPC 521/138; 524/451; 524/322

(57) ABSTRACT

A significant disadvantage of the use of polylactic acid (PLA), lack of good heat stability, has been overcome by the use of talc, optionally in combination with an acrylic impact modifier. The compound achieves a threshold of 100° C. in heat deflection temperature.

### CLAIM OF PRIORITY

This application claims priority from U.S. Provisional Patent Application Ser. No. 61/527,478 bearing Attorney Docket Number 12011018 and filed on Aug. 25, 2011, which is incorporated by reference.

### FIELD OF THE INVENTION

This invention relates to new compounds including polylactic acid and having increased heat resistance to improve structural integrity during use of the compound.

### BACKGROUND OF THE INVENTION

Plastic articles have replaced glass, metal, and wood articles because plastic can be engineered to not shatter, rust, or rot. The durability of plastic articles also creates a disposal dilemma. Also, many plastic resins are made from petrochemicals, which have long-term supply and cost issues.

Therefore, there is a considerable effort underway to find biologically-derived and sustainable sources of thermoplastic resins, preferably those which degrade or compost to also resolve the disposal dilemma.

Polylactic acid, also known as polylactide or PLA, has been explored as a thermoplastic resin from biologically sustainable origins which can replace petrochemically originated resins.

### SUMMARY OF THE INVENTION

While polylactic acid is probably one of the three most popular bio-derived resins being explored, it has the distinct disadvantage, as when compared to the fossil-derived resins it is meant to replace, in that it has a poor heat deflection temperature.

Heat deflection temperature (HDT) is a measurement of deflection of a sample under flexural load using the protocol of ASTM D648. The flexural load can be either of two settings. For purposes of this invention, 66 pounds per square inch (psi) or 455 kilo-Pascals (kPa) will be used for comparative measurements of heat deflection.

The problem with polylactic acid is that it has a heat deflection temperature under a 455 kPa flexural load of about 55° C. or 131° F. In other words, inside a automobile on an Arizona summer day, PLA would not be sturdy enough to be used as a thermoplastic resin molded into a passenger compartment component, as the case for an electronic handheld device laying on the seat, or as a piece of packaging containing perishable food in a grocery bag on the floor inside the automobile.

The problem with PLA is that it does not have sufficient heat resistance to allow it to be considered as a practical replacement for fossil-derived thermoplastic resins now used in many common plastic articles.

What the art needs is a heat resistant polylactic acid compound, in order that such compound can replace heat resistant thermoplastic compounds in which the thermoplastic resin is made from petrochemical sources obtained via mining or drilling into the earth.

Another problem with PLA in some end use applications is that it is not suitably tough, i.e., resistant to impact. Brittle thermoplastic compounds, even if heat resistant, are not suitable for commercial uses.

The present invention solves that problem by compounding PLA with a particular amount of talc and optionally an impact modifier, in order that the PLA compound has sufficient heat resistance and impact toughness to permit the PLA compound to replace a conventional thermoplastic compound.

The art has had a long-felt need for solving the heat resistance problem. Published literature of NatureWorks, LLC, a principal manufacturer of PLA, reports at www.natureworksllc.com that adding as much as 50% by weight of acrylonitrile-butadiene-styrene (ABS) to PLA to create a 50-50 PLA-ABS blend improves HDT by as little as 2° C. over the HDT of pure PLA polymer resin. Adding as much as 80% by weight of ABS to PLA does result in an improvement in HDT by 30° C., but at that mixture, it is actually more of an ABS polymer being modified by PLA.

Moreover, the art has had a long-felt need for solving the heat resistance problem, and it has been commonly characterized in some industries that a PLA compound should preferably have at least a 65° C. HDT at 66 psi to be a practical thermoplastic compound of both biologically sustainable origin and practical commercial use. At long last, the present invention has discovered also suitable combination of ingredients to achieve, and exceed, that goal of 100° C. at 66 psi.

The art needs a means to increase the actual HDT values for PLA, while also retaining the resulting compound as principally significantly a PLA compound.

For purposes of this invention, the PLA should be the “significant component”, meaning that PLA is present in at least about thirty weight percent (30%) of the compound.

It has been found, unexpectedly, that the combination of PLA, between 2 and 9 weight percent of talc, and optionally an acrylic impact modifier can increase the HDT of a PLA compound to more than 100° C.

One aspect of the present invention is a heat resistant, flame retardant polylactic acid compound, comprising: (a) polylactic acid; (b) polycarbonate; (c) talc in an amount of from about 2 to 9 weight percent of the compound; and optionally (d) acrylic impact modifier.

Another aspect of the present invention is a plastic article formed from the compound described immediately above.

Features and advantages of the compound of the present invention will be further explained with reference to the embodiments and the examples showing the unexpected results.

### EMBODIMENTS OF THE INVENTION

### PLA

PLA is a well-known biopolymer, having the following monomeric repeating group in Formula I:

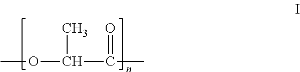

The PLA can be either poly-D-lactide, poly-L-lactide, or a combination of both. PLA is commercially available from NatureWorks, LLC located in all manufacturing regions of the world. Any grade of PLA is a candidate for use in the present invention. Currently, grades 4042D and 4032D are preferred. The number average molecular weight of PLA can be any which is currently available in a commercial grade or one which is brought to market in the future. To the extent that a current end use of a plastic article could benefit from being made from PLA and from having the heat resistance of the compound of the present invention, then that suitable PLA should be the starting point for constructing the compound of the present invention.

Polycarbonate

PC is truly a workhorse polymer well known to all skilled polymer chemists. It can be either aliphatic or aromatic in chemical character. It can be either a homopolymer or a copolymer in content.

Any commercially available PC is a candidate to be used in the present invention.

PC is commercially available in a number of grades from any number of commercial producers, including SABIC Innovative Plastics (formerly General Electric Plastics,) Dow Chemical Company, Bayer Corporation, and many other companies worldwide.

PC useful in the present invention has a melt flow rate (MFR) ranging from about 2.5 g/10 min tested @ 300° C. and 1.2 kgf load to about 60 g/10 min tested @ 250° C. and 1.2 kgf load per ASTM D 1238.

Talc Heat Resistant Agent

Talc is well known as a functional filler useful in polymer compounds. What is unexpected is that a particular amount of talc dramatically increases the HDT of blends of PLA and PC resins. More specifically, as is demonstrated in the examples below, in order to obtain a HDT of more than 100° C., the amount of talc can range from about 2 weight percent of the compound to 9 weight percent, but not 10 weight percent. Surprisingly, the addition of as little as 2 weight percent of talc increases HDT as much as 15% (from 94° C. to 108° C.). Even more surprisingly, the increase on weight percent of talc in the compound from 9 to 10 weight percent causes HDT to plummet more than 16% (from 105° C. to 88° C.).

Talc is a naturally occurring mineral, identified generally as a hydrous magnesium silicate having a Chemical Abstract Services Number of CAS #14807-96-6. Its formula is 3MgO.4SiO₂.H₂O.

Talc is available from a number of commercial sources. Non-limiting examples of such talc useful in this invention are Jetfil™ brand talcs from Luzenac America, Flextalc™ brand talcs from Specialty Minerals, and Talcron™ brand talcs from Mineral Technologies, Inc.

Talc can have particle sizes ranging from about 0.5 μm to about 20 μm and preferably from about 0.7 μm to about 7 μm.

Optional Impact Modifier

Any conventional impact modifier is a candidate for use in compounds of the present invention. Core/shell impact modifiers, rubbery impact modifiers, etc. are suitable.

Of the various impact modifier candidates, Paraloid™ brand core/shell acrylic impact modifiers from Dow Chemical are suitable.

Acrylic impact modifier is optional, but preferred in this invention because more end use applications require impact resistance or toughness, than those which do not.

Optional Flame Retardant

Non-halogen flame retardant additives for thermoplastic compounds can be selected from the categories of a variety of phosphorus-containing chemicals. Non-limiting examples of phosphorus-containing chemicals include polyphosphonates, metal phosphinates, melamine (poly)phosphates, polyphosphazenes, and polyphosphonate-co-carbonate, described in U.S. Pat. No. 7,645,850 (Freitag), which disclosure is incorporated by reference herein.

Optional Drip Suppressant

Any conventional drip suppressant is a candidate for use in the present invention because drip suppressants assist in the compound retain integrity during burning.

As identified in the published literature from Kaneka Corporation, a polycarbonate-containing compound using a siloxane/(meth)acrylate core/shell impact modifier can benefit from the addition of a drip suppressant, such as polytetrafluoroethylene (PTFE). Compounds of the present invention preferably include minor amounts of PTFE.

An additional benefit of the use of PTFE is that it is a known lubricant to assist in processing of the compound during melt-mixing or during final shaping of the plastic article.

Other Optional Additives

The compounds of the present invention can include other conventional plastics additives in an amount that is sufficient to obtain a desired processing or performance property for the compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fire and flame retardants and smoke suppressants; initiators; lubricants; pigments, colorants and dyes; plasticizers; processing aids; release agents; slip and anti-blocking agents; stabilizers; stearates; ultraviolet light absorbers; viscosity regulators; waxes; and combinations of them.

Table 1 shows acceptable, desirable, and preferable ranges of ingredients useful in the present invention, all expressed in weight percent (wt. %) of the entire compound.

TABLE 1

| | Acceptable | Desirable | Preferable |
|---|---|---|---|
| PLA | 40-50 | 42-48 | 44-46 |
| Polycarbonate | 30-55 | 35-45 | 35-40 |
| Talc | 2-9 | 2-7 | 4-7 |
| Optional Acrylic Impact | 0-15 | 1-15 | 9-11 |
| Modifier | | | |
| Optional Flame Retardant | 0-30 | 0-20 | 0-15 |
| Optional Drip Suppressant | 0-2.0 | 0-1.5 | 0-0.5 |
| Other Optional Additives | 0-10 | 0-10 | 0-10 |

Processing

The preparation of compounds of the present invention is uncomplicated and can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 700 revolutions per minute (rpm), and preferably from about 100 to about 300 rpm. Typically, the output from the extruder is pelletized for later shaping by extrusion or molding into polymeric articles.

Mixing in a batch process typically occurs in a mixer that is also elevated to a temperature that is sufficient to melt the polymer matrix to permit addition of the solid ingredient additives. The mixing speeds range from 60 to 1000 rpm. Also, the output from the mixer is chopped into smaller sizes for later shaping by extrusion or molding into polymeric articles.

Optionally, prior to batch or continuous melt-mixing, one can dry the ingredients to help reduce the possibility of a moisture-activated degradation or reaction in the melt-mixing vessel. Alternatively, one can use other ways to reduce degradation possibilities, such as incorporating a moisture scavenger or desiccant into the formulation, applying a vacuum within the melt-mixing vessel, etc. Any of these techniques, or combination of techniques, results in the ingredients being dried before or during melt-mixing.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

Regardless of optional drying or other techniques during melt-mixing, it has been found that minimizing the moisture content in the compound before molding can have a direct effect on performance properties, including heat deflection temperature. Moisture content should be less than about 0.2%. The amount of drying should be much closer to about 48 hours than about 4 hours, in order to achieve an essentially dry blended compound prior to molding, i.e., having a moisture content of less than 0.1%. To reduce the possibility of drying at a temperature approaching the heat deflection temperature of 65° C., the temperature can be up to about 60° C. without vacuum. Indeed, without undue experimentation, one can identify the best combination of time, temperature, and atmospheric pressure to reduce the time of drying while maximizing the amount of drying, without approaching a temperature which would degrade or otherwise affect performance of the compound shaped as a molded or extruded product.

### Usefulness of the Invention

Any plastic article is a candidate for use of the compounds of the present invention. With the heat durability of PLA now achieved, all types of plastic articles which required an elevated HDT (and preferably a HDT of at least 100° C. at 66 psi), previously made from fossil-derived polymers, can now be made from a sustainable PLA polymer compound.

Plastic articles made from compounds of the present invention can be shaped via molding or extruding for use in the transportation, appliance, electronics, building and construction, biomedical, packaging, and consumer markets.

For example, food packaging can now be made from a PLA compound of the present invention and retain sufficient heat resistance to withstand storage or transport at temperatures approaching 100° C. The plastic article made from a compound of the present invention will retain its structural integrity at least 5° C. higher than with PLA alone and preferably at temperatures exceeding 100° C., the boiling point of water.

Examples prove the unexpected nature of the present invention.

### EXAMPLES

### Comparative Examples A-C and Examples 1-7

Table 2 shows the list of ingredients. Table 3 shows the extrusion conditions. Table 4 shows the molding conditions. Table 5 shows the recipes and the specific gravity according to ASTM D-792, tensile properties according to ASTM D-638, flexural properties according to ASTM D-790, Notched Izod impact according to ASTM D-256, and HDT at 66 psi according to ASTM D648.

TABLE 2

| Brand Name | Ingredient and Purpose | Commercial Source |
|---|---|---|
| GTP-323 PC | Polycarbonate resin | GeoTech Polymers |
| IRGANOX | Blend of organophosphate | BASF (formerly |
| B225 | stabilizer and phenolic | Ciba Geigy) |
| | antioxidant | |
| PARALOID | Acrylic impact modifier | Dow Chemical |
| KM334 | | (formerly Rohm and |
| | | Haas) |
| Ingeo 4032D | Polylactic acid resin | NatureWorks LLC |
| PLA | | |
| JETFIL 700C | Talc heat resistant agent | Luzenac America |
| TALC | | |
| Joncryl ADR- | Epoxy Functional Styrene- | BASF (formerly |
| 4300 | Acrylate Oligomeric Chain | Johnson Polymers) |
| | Extender | |
| TIONA 188 | Titanium dioxide colorant | Millenium |
| | | Chemicals |
| FLEXTALC | Talc heat resistant agent | Specialty Minerals |
| 610D | | |
| TALCRON MP | Talc heat resistant agent | Minerals |
| 12-50 | | Technologies Inc. |

TABLE 3
Extruder Conditions
All Comparative Examples and Examples

| Extruder Type | WP 25 mm twin screw extruder |
|---|---|
| Order of Addition | All ingredients mixed together and fed |
| | into the extruder hopper. |
| All Zones and Die (° C.) | 200~210° C. |
| RPM | 450 |

TABLE 4
Molding Conditions
All Comparative Examples and Examples
88 ton Nissei molding machine
Drying Conditions before Molding:

| | |
|---|---|
| Temperature (° C.) | 70 |
| Time (h) | 6 |

Temperatures:

| | |
|---|---|
| Nozzle (° C.) | 228 |
| Zone 1 (° C.) | 223 |
| Zone 2 (° C.) | 221 |
| Zone 3 (° C.) | 221 |
| Mold (° C.) | 65 |
| Oil Temp (° C.) | 29 |

Speeds:

| | |
|---|---|
| Screw RPM (%) | 50 |
| % Shot - Inj Vel Stg 1 | 40 |
| % Shot - Inj Vel Stg 2 | 35 |
| % Shot - Inj Vel Stg 3 | 30 |
| % Shot - Inj Vel Stg 4 | 20 |
| % Shot - Inj Vel Stg 5 | 10 |

Pressures:

| | |
|---|---|
| Hold Stg 1 (mPa) - | 3.5 |
| Time (sec) | 5 |
| Hold Stg 2 (mPa) - | 3 |
| Time (sec) | 5 |

Timers:

| | |
|---|---|
| Injection Hold (sec) | 7 |
| Cooling Time (sec) | 20 |

Operation Settings:

| | |
|---|---|
| Shot Size (mm) | 55 |
| Cushion (mm) | 1.5-1.8 |

TABLE 5

| | Example | | | | |
|---|---|---|---|---|---|
| | A | B | 1 | C | 2 |
| GTP-323 PC | 44.8 | 43.3 | 39.8 | 34.8 | 42.8 |
| IRGANOX B225 | 0.2 | 0.2 | 0.2 | 0.2 | 0.2 |
| PARALOID KM334 | 10.0 | 10.0 | 10.0 | 10.0 | 10.0 |
| Ingeo 4032D PLA | 45.0 | 45.0 | 45.0 | 45.0 | 45.0 |
| JETFIL 700C TALC | | | 5.0 | 10.0 | 2.0 |
| Joncryl ADR-4300 | | 0.5 | | | |
| TIONA 188 | | 1.0 | | | |
| FLEXTALC 610D | | | | | |
| TALCRON MP 12-50 | | | | | |
| Total | 100.0 | 100.0 | 100.0 | 100.0 | 100.0 |
| Specific Gravity (ASTM | 1.21 | 1.21 | 1.25 | 1.28 | 1.23 |
| D-792) | | | | | |
| Ultimate Tensile @ yield | 7850 | 8600 | 7890 | 7680 | 8270 |
| (psi) - 0.2 (ASTM D-638 | | | | | |
| (Rigid)) | | | | | |
| Tensile @ Break - 2 in/min | | | | | 5783 |
| (ASTM D-638 | | | | | |
| (Rigid)) | | | | | |
| Tensile Modulus (psi) - | 272,294 | 369,000 | 363,374 | 393,801 | 317,132 |
| 0.2 in/min (ASTM D-638) | | | | | |
| Elongation @ Break - 0.2 in/min | 44 | 50 | 77 | 68 | 44 |
| (ASTM D-638) | | | | | |
| Flexural Modulus (psi) - | 373,000 | 395,000 | 477,000 | 454,000 | 441,000 |
| 0.5 in/min (ASTM D-790) | | | | | |
| Flexural Yield (psi) - 0.5 in/min | 12,770 | 13,730 | 14,040 | 14,010 | 14,180 |
| (ASTM D-790) | | | | | |
| Izod, ⅛″ (3.57 mm) RT | 12 | 15 | 7.7 | 5.7 | 8.9 |
| (ASTM D-256) | | | | | |
| HDT @ 66 PSI (° C.) | 94 | 121 | 123 | 88 | 108 |
| (ASTM D-648) | | | | | |
| | Example | | | | |
| | 3 | 4 | 5 | 6 | 7 |
| GTP-323 PC | 40.8 | 37.8 | 35.8 | 39.8 | 39.8 |
| IRGANOX B225 | 0.2 | 0.2 | 0.2 | 0.2 | 0.2 |
| PARALOID KM334 | 10.0 | 10.0 | 10.0 | 10.0 | 10.0 |
| Ingeo 4032D PLA | 45.0 | 45.0 | 45.0 | 45.0 | 45.0 |
| JETFIL 700C TALC | 4.0 | 7.0 | 9.0 | | |
| Joncryl ADR-4300 | | | | | |
| TIONA 188 | | | | | |
| FLEXTALC 610D | | | | 5.0 | |
| TALCRON MP 12-50 | | | | | 5.0 |
| Total | 100.0 | 100.0 | 100.0 | 100.0 | 100.0 |
| Specific Gravity (ASTM | 1.24 | 1.26 | 1.27 | 1.25 | 1.25 |
| D-792) | | | | | |
| Ultimate Tensile @ yield | 8410 | 8416 | 8410 | 8430 | 8340 |
| (psi) - 0.2 (ASTM D-638 | | | | | |
| (Rigid)) | | | | | |
| Tensile @ Break - 2 in/min | 5757 | 5684 | 5647 | 5558 | 5739 |
| (ASTM D-638 | | | | | |
| (Rigid)) | | | | | |
| Tensile Modulus (psi) - | 341,590 | 355,591 | 378,094 | 342,490 | 346,327 |
| 0.2 in/min (ASTM D-638) | | | | | |
| Elongation @ Break - 0.2 in/min | 51 | 29 | 30 | 36 | 45 |
| (ASTM D-638) | | | | | |
| Flexural Modulus (psi) - | 468,000 | 504,000 | 540,000 | 479,000 | 473,000 |
| 0.5 in/min (ASTM D-790) | | | | | |
| Flexural Yield (psi) - 0.5 in/min | 14,350 | 14,290 | 14,350 | 14,330 | 14,040 |
| (ASTM D-790) | | | | | |
| Izod, ⅛″ (3.57 mm) RT | 7.3 | 5.6 | 4.5 | 7.3 | 6.4 |
| (ASTM D-256) | | | | | |
| HDT @ 66 PSI (° C.) | 117 | 119 | 105 | 105 | 116 |
| (ASTM D-648) | | | | | |

Table 5 shows the progression of experimentation to produce this invention. Comparative Example A is a formulation with no talc present. Comparative Example B is a formulation with no talc present but with Joncryl oligomer and Tiona titanium dioxide which is a formulation previously found to have a HDT of more than 120° C. Example 1 shows the use of 5 weight percent of talc is slightly better in HDT than Comparative Example B. But Comparative Example C shows that the use of 10 weight percent of talc is quite unsatisfactory, surprisingly even worse than Comparative Example A having no talc at all.

Given these unexpected results, a second series of experiments was performed, Examples 2-7, to determine how the particular amount of talc performs in the range from 2 weight percent to 10 weight percent. Examples 2-5 only differ in the amount of talc present. As explained previously, adding merely 2 weight percent of talc increases HDT by almost 15% (Comparative Example A to Example 2). And even more surprisingly, increasing talc content from 9 to 10 weight percent causes a drop in HDT of 16% (Example 6 to Comparative Example C).

Even within the range of 2 to 9 weight percent of talc, the peak of HDT performance at 5 weight percent is asymmetrical, with the drop in HDT greater between 5 and 4 weight percent than 4 and 7 weight percent.

Regardless of the weight percent of talc between 2 and 9, the physical properties for elasticity (tensile), toughness (Notched Izod), flexibility (flexural), and density (specific gravity) as determined all by ASTM test procedures are acceptable for Examples 1-5, even though toughness is not as not strong as found in Comparative Example B.

Examples 6 and 7 demonstrate that alternative sources of talc give acceptable results at the 5 weight percent, though not as high as that of the Jetfil™ 700C talc used, which is preferred.

The invention is not limited to the above embodiments. The claims follow.

What is claimed is:

1. A heat resistant, polylactic acid compound, comprising:
(a) polylactic acid;
(b) polycarbonate;
(c) talc in an amount from about 2 to 9 weight percent of the compound; and optionally
(d) acrylic impact modifier.

2. The compound of claim 1, optionally also comprising flame retardant and drip suppressant.

3. The compound of claim 1 or claim 2, wherein the talc comprises 2 to 7 weight percent of the compound.

4. The compound of claim 3, wherein the talc comprises 4 to 7 weight percent of the compound.

5. The compound of claim 4, wherein the acrylic impact modifier is present in an amount of from about 1 to about 15 weight percent of the compound.

6. The compound of claim 1, wherein if the blended compound is essentially dried before shaping into a plastic article, then the blended compound after shaping into the plastic article has a heat deflection temperature of at least 100° C. at 66 pounds per square inch using the protocol of ASTM D648.

7. The compound of claim 1, wherein the polylactic acid comprises poly-D-lactide, poly-L-lactide, or a combination of both and wherein the amount of polylactic acid is present in the compound ranges from about 40 to about 50 weight percent.

8. The compound of claim 1, wherein the polycarbonate is present in the compound from about 30 to about 55 weight percent.

9. The compound of claim 5, wherein the impact modifier is a core/shell acrylic polymer.

10. The compound of claim 1, further comprising optional additives selected from the group consisting of adhesion promoters; biocides; anti-fogging agents; anti-static agents; bonding, blowing and foaming agents; dispersants; initiators; lubricants; pigments, colorants and dyes; plasticizers; processing aids; release agents; slip and anti-blocking agents; stabilizers; stearates; ultraviolet light absorbers; viscosity regulators; waxes; and combinations of them.

11. A plastic article shaped from a compound of claim 1.

12. The article of claim 11, wherein the article is molded or extruded and wherein the article is shaped for use in transportation, appliance, electronics, building and construction, packaging, or consumer markets.

13. The article of claim 11, wherein the article has a heat deflection temperature increase of at least 45° C. more than the heat deflection temperature of a plastic article made of polylactic acid alone, when both are measured at 66 pounds per square inch using the protocol of ASTM D648.

14. A method of making the compound of claim 1, comprising the steps of
(a) gathering ingredients including polylactic acid, polycarbonate, talc, and optionally, impact modifier,
(b) melt-mixing them into a compound for subsequent shaping into a plastic article shaped for use in transportation, appliance, electronics, building and construction, packaging, or consumer markets.

15. The method of making the compound of claim 14, further comprising the steps of
(c) drying the compound to a moisture content of less than 0.2% and
(d) shaping the compound into a plastic article for use in transportation, appliance, electronics, building and construction, packaging, or consumer markets.
